(19) United States
(12) Patent Application Publication
(10) Pub. No.: US 2003/0056314 A1
(43) Pub. Date: Mar. 27, 2003

(54) Wiper arm and windshield wiper device and method for making a wiper arm for a wiper device of a motor vehicle

(76) Inventors: Laurent Heinrich, Illkirch-Graffenstaden (FR); Karlheinz Lorenz, Baden-Baden (DE)

Correspondence Address: STRIKER, STRIKER & STENBY, 103 East Neck Road, Huntington, NY, 11743, US

(21) Appl. No.: 10/231,344

(22) Filed: Aug. 29, 2002

(30) Foreign Application Priority Data
Sep. 21, 2001 (DE) 101 46 721.4

(51) Int. Cl. B60S 1/36; B60S 1/24

(52) U.S. Cl. 15/250.21; 29/897.2; 15/27

(57) ABSTRACT

A wiper arm (14) for a wiper device has at least one attachment part (24) with a support part (20) and two cranks (28, 30), which are pivoted by means of two bearings (47, 50) on the support part (40). The bearing box of the bearing (47, 50) is injected into the support part (40). A method for producing the wiper arm is also provided.

### BACKGROUND OF THE INVENTION

The present invention relates to a wiper arm and a wiper device, in particular, for a motor vehicle.

Many types of wiper arms for wiper devices with four-bars for motor vehicles are already known, for example, from DE 40 32 762 C2. In this wiper device, the wiper arm comprises a pivoting part and an attachment part with two cranks, by means of which the wiper arm is pivoted on the wiper device. By means of a swinging movement of one of the cranks, the wiper completely guides a pendulum lift movement, which permits the stroking-over of a favorable surface as a mere pendulum or swinging movement, in which a circular ring element is swiped over. Since between the cranks and the attachment part, large forces are to be transmitted, the attachment part must be formed to be particularly stable and have a relative large height.

### SUMMARY OF THE INVENTION

The wiper arm of the present invention has the advantage that the attachment part has two cranks, each of which is connected rotatably with a bearing bolt, whereby the attachment part comprises a support part, into which the bearing box for the bearing bolt is injected. In this manner, the height of the attachment part, and therewith the entire wiper arm, can be reduced, which is positive for the flow characteristics and which acts on the wind noise of the wiper arm. In addition, fewer materials are needed to manufacture such a wiper arm, so that the costs for the wiper arm are reduced. Further, the minimal height achieves an improved optical system, since the wiper arm can be hidden in the park position, for example, under the engine hood of the motor vehicle.

It is particularly advantageous when the bearing box is formed as a ball cup or socket and the bearing bolt is formed as a spherical bolt. In this manner, the crank that is rotatably connected with the bearing bolt can be pushed into the bearing box without axial attachment, if the bearing box includes more than one half-sphere of the bearing bolt.

In addition, it is also advantageous if the bearing bolt engages through the support part in the entire length. In this manner, it is possible that within the interior of the bearing between the bearing box and bearing bolt, the largest surface area possible can be contacted, so that the abrasion of the bearing is reduced by an optimal division of force.

It is particularly advantageous if the bearing bolt engages through the crank in its full length and is attached to the crank on a side turned away from the bearing box. In this way, the shearing force, which occurs between the bearing bolt in the area of the bearing box and the crank, does not operate in the area of the attachment, thereby providing an increased stability of the bearing bolt.

In addition, it is advantageous if form-locking, locking elements for locking the bearing box are provided on the support part, in order to avoid a twisting of the bearing box in operation.

Moreover, it is advantageous if the first crank is supported by means of a cylindrical bearing bolt and the second crank is supported by means of a spherical bearing bolt in the support part. In this manner, the bearing force can be reduced, if the drive axes of the cranks are not exactly parallel to one another, as is commonly the case in serial manufacturing in the frame of standard tolerances.

The wiper arm of the present invention, which has an attachment part with two cranks, in which the first crank is hinged on the support part by a swivel joint and the second crank is hinged on the support part by a ball and socket joint, has the advantage that the bearing forces are reduced through the two-dimensional movement possibilities of the second crank, when the drive axes of both cranks are not exactly parallel to one another.

It is also advantageous when at least the support part is protected from environmental effects by a cover, in order to prevent contamination and corrosion on the support part and particularly, on the bearing.

### BRIEF DESCRIPTION OF THE DRAWINGS

FIG. 1 shows a wiper device with a wiper arm of the present invention in a schematic representation; and

FIG. 2 shows a section through the attachment part of the wiper arm of the present invention.

### DETAILED DESCRIPTION OF THE PREFERRED EMBODIMENTS

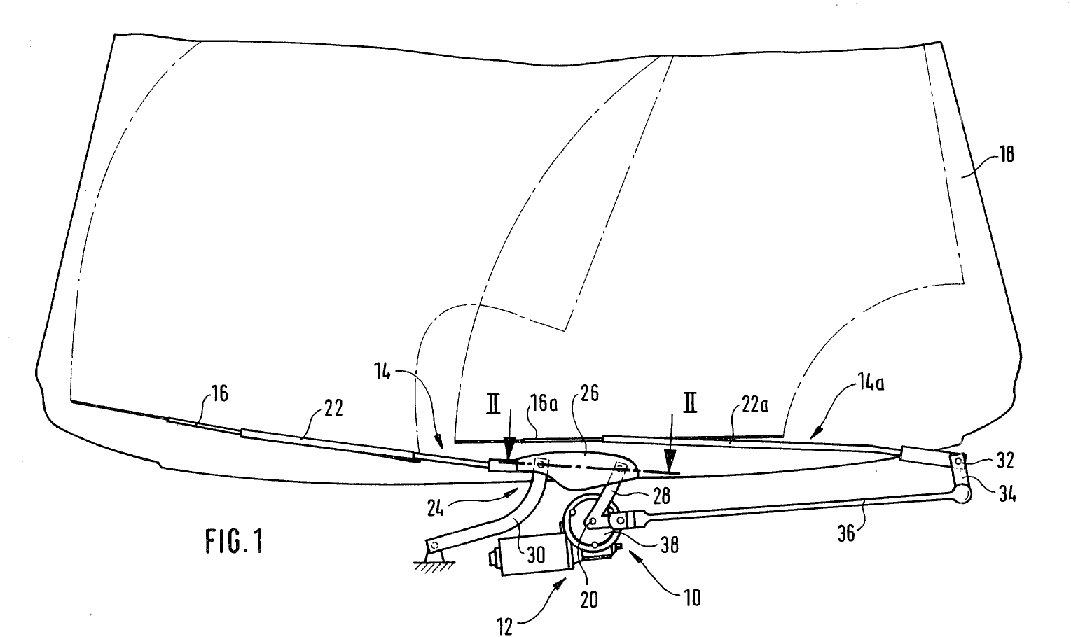

FIG. 1 shows the wiper device 10 of the present invention in a schematic representation. The device 10 comprises generally a drive apparatus 12, which drives two wiper arms 14, 14a, on which wiper blades 16, 16a are attached. The wiper blades 16, 16a glide swingingly over a pane 18, for example, the windshield of a motor vehicle.

The drive apparatus 12 is formed, by way of example, as a rotary or reversing electric motor, whose armature shaft meshes a worm gear by means of a worm. The shaft of the worm gear forms the drive shaft 20 of the drive apparatus 12.

The wiper arms 14, 14a, respectively, have a joint part 22, 22a, which is rotatably connected on an end with the wiper blade 16 or 16a. A joint part 22 of the wiper arms 14, 14a is connected to the end facing away from the wiper blade 16 with an attachment part 24, which generally comprises a longitudinal portion 26 and two cranks 28, 30. The two cranks 28, 30, respectively, are attached rotatably with an end on the longitudinal portion 26. The first crank 28 is nonrotatably connected to the drive shaft 20 of the drive apparatus 12 with its end facing away from the longitudinal portion 26. The second crank 20 is rotatably linked to the vehicle body or to a stationary support on the wiper drive with a constant distance to the drive shaft 20 with its end facing away from the longitudinal portion 26.

The driver-side wiper arm 14a, as is common, is rotatably connected via a wiper support 32 with a drive crank 34, which, in turn, is connected via a connecting rod 36 eccentrically to the drive shaft 20, for example, via a lever 38 arranged in a fixed angle to the first crank 28 or directly on the first crank 28, so that the end of the connecting rod 26 by the drive completely performs a circular movement or a movement of at least a section of an arc of a circle.

When the drive shaft 20 guides a rotational movement, the driver-side wiper blade 16a moves over the pane 18 and swipes over the surface of a circular ring segment. The passenger-side wiper blade 16 swipes over a surface, which corresponds to the surface of a circular ring element, which, however, is superimposed with a lift movement.

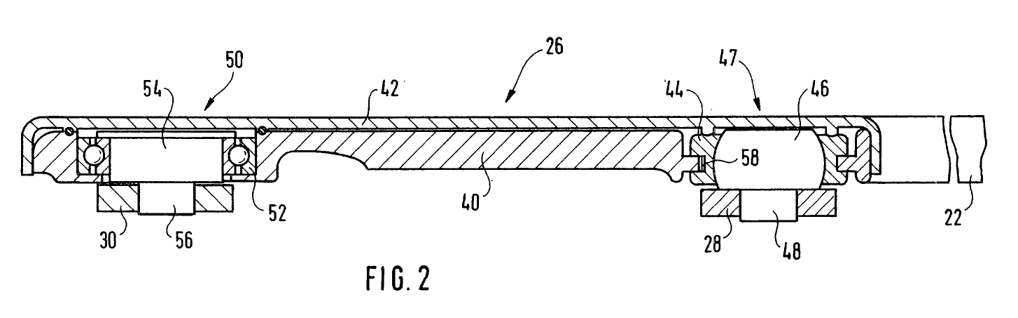

In FIG. 2, a cross section through the attachment part 24 is shown. The longitudinal portion 26 comprises a support part 40, which is covered by a cover 42. In the support part 40, a bearing box 44 is injected, which has a ball cup or socket section on its interior, in which a spherical bolt 46 is supported. The bearing box 44 and the spherical bolt 46 form a spherical bearing 47 in this manner.

The spherical bolt 46 essentially comprises a spherical section, on which a cylindrical section 48 is connected. This cylindrical section 48 engages through the first crank 28 in its entire thickness, or is otherwise formulated to be inserted in a bore in the first crank 28 and is secured to the side of the first crank 28 facing away from the spherical bearing 47 by welding or caulking. The second crank 30 is attached to the support art 40 via a second bearing 50.

The second bearing 50 comprises a spherical bearing 52, whose outer ring is pressed into the support part 40. The inner ring of the spherical bearing 52 supports the cylindrical bolt 54, which is wedged over with the inner ring. The cylindrical bolt 54 is tapered outside the area of the spherical bearing 52. This tapered section 56 is inserted in a bore of the second crank 30 and rotatably connected to it. This is achieved, for example, by the tapered section 56 engaging through the second crank 30 in its entire thickness and welding, caulking, or riveting it on the side facing away from the second bearing 50.

The joint part 22 is connected to the support part 40 of the longitudinal portion 26 (FIG. 1) by means of a joint, which permits a folding of the wiper arm 14 from the surface to be swiped, for example, for changing the wiper blade 16. The support part 40 is manufactured in an injection-molding process. In the area of the bearing box 44, injected in the support part 40, the support part 40 has locking elements 58, which, for example, have a toothed structure and prevent the injected bearing box 44 from loosening from the support part 40 during operation and rotating with the spherical bolt 46.

The support part 40 can also be manufactured from a carbon fiber material, so that the weight of the longitudinal portion 26 can be reduced. The bearing boxes 44 can be manufactured from plastic. Upon manufacturing of the wiper arm of the present invention, the support part 40 can be inserted in an injection mold for the bearing boxes 44 and subsequently, the material for the bearing boxes 44 can be injected so that the bearing boxes are directly injected onto the support part 40. Next, the cranks 28, 30 can be connected with the spherical bolt, and the cranks 28, 30 pressed into the bearing boxes 44. Of course, the cranks 28, 30 also can be manufactured from a carbon material.

It will be understood that each of the elements described above, or two or more together, may also find a useful application in other types of constructions differing from the types described above.

While the invention has been illustrated and described herein as a wiper arm and windshield wiper assembly and a method for manufacturing a wiper arm for a wiper device of a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A wiper arm (14), in particular, for a wiper device of a motor vehicle, comprising, an attachment part (24), said attachment part (24) having a first crank (28) and a second crank (30) for pivoting of the wiper arm (24) at two points, wherein at least one of the first and second cranks (28, 30) is rotatably connected with a bearing bolt (46), wherein the attachment part (24) has at least one support part (40) and a bearing box (44) injected into said support part (40), and wherein the bearing bolt (46) sits in the bearing box (44).

2. Wiper arm as defined in claim 1, wherein the bearing box (44) is formed as a ball or cup socket and the bearing bolt (46) is formed as a spherical bolt.

3. Wiper arm as defined in claim 1, wherein the bearing bolt (46) engages through the bearing box (44) and/or the support part (40) in an entire length.

4. Wiper arm as defined in claim 1, wherein at least one bearing bolt (46) engages through at least one of said first and second cranks (28, 30) in an entire length and is attached to the at least one crank (28, 30) on a side facing away from the bearing box (44).

5. Wiper arm as defined in claim 1, wherein locking elements (58) are provided on the support part (40) for locking the bearing box (44).

6. Wiper arm as defined in claim 1, wherein the first crank (28) is supported by means of at least a partially cylindrical bearing bolt (54) and the second crank is supported by means of a spherical bearing bolt (44) in the support part (40).

7. Wiper arm, in particular, for a wiper device of a motor vehicle, comprising an attachment part (24), said attachment part (24) having at least a first crank (28) and a second crank (30) for pivoting of the wiper arm at two points of the wiper device and including a support part (40), wherein the at least one first crank (28) is pivoted by means of a pivot joint (50) and the second crank (30) is pivoted by means of a ball and socket joint (47) on the support part (40).

8. Wiper arm as defined in claim 7, wherein at least the support part (40) is protected by a cover (42) from environmental effects.

9. Wiper device, in particular, for a motor vehicle, comprising a wiper arm (14) having an attachment part (24), said attachment part (24) having a first crank (28) and a second crank (30) for pivoting of the wiper arm (24) at two points, wherein at least one of the first and second cranks (28, 30) is rotatably connected with a bearing bolt (46), wherein the attachment part (24) has at least one support part (40) and a bearing box (44) injected into said support part (40), and wherein the bearing bolt (46) sits in the bearing box (44).

10. Method for making a wiper arm, comprising the following steps:
making a support part (40);
injection-molding at least one bearing box (44); and
inserting a bearing bolt (46) into the at least one bearing box (44).
